(19) United States
(12) Patent Application Publication
(10) Pub. No.: US 2010/0027985 A1
(43) Pub. Date: Feb. 4, 2010

(54) In-finder display apparatus

(76) Inventors: Keitaro Yokoyama, Hachioji-shi (JP); Ryuji Kamada, Hino-shi (JP)

Correspondence Address: Richard M. Rosati, Esq.;Kenyon & Kenyon LLP, One Broadway, New York, NY, 10004, US

(21) Appl. No.: 12/460,877

(22) Filed: Jul. 27, 2009

(30) Foreign Application Priority Data
Aug. 1, 2008 (JP) 2008-199267
Sep. 9, 2008 (JP) 2008-230740

(51) Int. Cl. G03B 13/06

(52) U.S. Cl. 396/384

(57) ABSTRACT

An in-finder display apparatus comprises:
a finder optical system adapted to view an object image formed by a taking lens on a focal plane plate by means of an eyepiece lens through a penta roof prism,
a display cell located on a display member disposed near an imaging plane for the object image, and
an illuminating optical system for illuminating the display cell.

The display cell is illuminated by the illuminating optical system so that light reflected off the display cell together with the object image is viewable via the finder optical system.

The illuminating optical system comprises:
a light emitting means, and
a light projecting lens for converging a light beam leaving the light emitting means.

The illuminating optical system is positioned such that an illuminating light beam leaving the light emitting means in the illuminating optical system enters the display cell after transmitting through the light projecting lens.

This application claims benefit of Japanese Application No. 2008-199267 filed in Japan on Aug. 1, 2008 and Japanese Application No. 2008-230740 filed in Japan on Sep. 9, 2008, the contents of which are incorporated by this reference.

### BACKGROUND OF THE INVENTION

The present invention relates generally to a display apparatus for finders, and more particularly to an in-finer display apparatus capable of producing superimposed displays in the finder of a single-lens reflex camera.

So far, among cameras designed to take photographs, those equipped with an autofocusing mechanism (hereinafter called the AF mechanism) have gained popularity in general. Practically available is now a display apparatus that mounted on the finder of a camera having such an AF mechanism and comprises a plurality of range-finding frames (AF frames) for producing so-called superimposed displays, wherein a range-finding frame selected from the plurality of range-finding frames is displayed while it is superimposed on an object image (called a finder field image) within a finder field frame.

In some conventional display apparatus for finders capable of implementing such superimposed display, for instance, a position where the desired display is implemented is defined as the “position of a range-finding frame out of a plurality of range-finding frames to which autofocusing is applied” and the then displaying is switched over to “in-focus state” or “out-of-focus state”, so that the displays can be shown while superimposed on the finder field image. Such displaying enables the operator of the camera to have a very institutive understanding of what is displayed, and the operator to take photographs very easily.

Among display means in such display apparatus for finders, there is the one where a light-emitting type illuminating member such as a light emitting diode (LED) is used to produce displays or none by switching over to the on-state or off-state. The display apparatus capable of such an illuminating emission type of superimposed displays is advantageous in that it is less likely for the operator to overlook displays because of making sure high visibility upon put on. Another advantage is that various display colors are selectively usable depending on illuminating light sources: if light emitting displays are produced even when objects have low brightness and there is dimness in the finder field frame, very high visibility is ensured for the displays themselves.

For cameras equipped with conventional display apparatus for finders capable of producing such superimposed displays, there is a display apparatus proposed in the art, wherein a display cell comprising a set of microprisms is provided on a display member that is located adjacent to the focusing screen of a camera, and when illuminating light from an illuminating arrangement is obliquely incident onto it, only light reflected off said microprisms is allowed to be incident onto a finder optical system so that the display cell is visually identified through the finder.

Such display apparatus for finders, for instance, are set forth in Patent Publication 1, Patent Publication 2, etc.

In this case, some contrivances are applied to the display cell capable of producing superimposed displays, making sure illuminating light from an illuminating unit is guided to an eye point for improved visibility.

Such a display cell capable of producing superimposed displays, for instance, is proposed in Patent Publication 4, Patent Publication 5, etc.

A display apparatus for finders set forth in Patent Publication 1 is primarily used for the display apparatus for the finder of a single-lens reflex camera equipped with a finder unit comprising a penta prism or the like. Note here that FIG. 10 is illustrative in section and schematic of part of the display apparatus for finders set forth in Patent Publication 1: it is illustrative of how that display apparatus is laid out in the camera. As shown in FIG. 10, an illuminating member 8 comprising an LED unit 9 for producing superimposed displays is located in a space diagonally above a penta prism 7, and illuminating light from this illuminating member is incident down onto the penta prism 7 from its given surface 7b. In this case, the exit surface 7a of the penta prism 7 makes a given angle θ (110°<θ<165°) with the given surface 7b. Moreover, the illuminating light is also incident onto an optical plane plate 6 functioning as a display member via the penta prism 7.

A display apparatus for finders set forth in Patent Publication 2, too, is the one for the finder of a single-lens reflex camera equipped with a finder unit comprising a penta prism or the like, as is the case with Patent Publication 1. Note here that FIG. 11 is illustrative in schematic and section of how part of the display apparatus for finders disclosed in Patent Publication 2 is mounted in the camera. As shown in FIG. 11, a display apparatus 20 for producing superimposed displays comprises a light emitting element 18 comprising a light emitting means such as an LED, and illuminating light from the display apparatus 20 is incident from a side wall face between the entrance and roof surfaces of a penta prism 17 via a sub-prism 27, with oblique incidence of illuminating light onto a display member 22.

Display cells capable of implementing superimposed displays set forth in Patent Publication 3 each comprise a microprism, and it teaches that the angle of incidence of illuminating light from an illuminating means onto said microprism is kept substantially orthogonal to the ridgeline of said microprism so that the operator (viewer) can identify all display cells without turning the eye upon them, resulting in improvements in the visibility of images in the field of the finder.

In a display cell capable of implementing superimposed displays set forth in Patent Publication 4, in the vicinity of finder images constituting a finder screen, there is a microprism located that forms information in a display pattern, and at least one surface of that microprism is allowed to have power in one direction alone so that illuminating light can be guided to an eye point in a limited space arrangement, resulting in improvements in the visibility of images in the field of the finder.

A display cell for implementing superimposed displays set forth in Patent Publication 5 comprises a plurality of microprisms, and it teaches that said plurality of microprisms are each in a triangular shape in cross section with its vertex angle being the same throughout all the microprisms, and that the ridgeline of each microprism is set parallel with the horizontal direction of a finder screen so that the types of their angles of inclination are reduced, helping simplify micro-prism production.

Patent Publication 1: JP(A)2005-331930

Patent Publication 2: JP(A)2006-10782

Patent Publication 3: JP(A)2000-122156

Patent Publication 4: JP(A)2001-075149

Patent Publication 5: JP(A)2004-219916

The in-finder display apparatus set forth in Patent Publication 1 has illuminating light obliquely incident onto the display member via the penta prism; however, to have an aperture on the entrance side thereby preventing an illuminating light beam from being shielded off in the penta prism, it is required to make the penta prism large. This arrangement is unsuitable for size reductions of the penta prism itself. There is also an increase in the length of an optical path through the penta prism on the optical axis of the finder optical system: the focal length of the finder grows long. This arrangement is unsuitable for increasing the magnification of the finder.

The display apparatus for finders set forth in Patent Publication 2 is unsuitable for size reductions of the penta prism itself, because its size grows large in the horizontal direction of FIG. 5 due to the fact that the illuminating light is incident from the side wall face between the entrance surface and the roof surface of the penta prism via the sub-prism. A lot more polished surfaces are needed for the incidence of illuminating light from the side wall face of the penta prism, and moreover, they must be bonded to the sub-prism, contributing no or little to cost reductions.

In any one of the inventions set forth in Patent Publications 3, 4 and 5, too, there is a microprism located on the display cell capable of producing superimposed displays. Illuminating light from the illuminating means is totally reflected at the first and second slanting facets, twice at each, for guiding it to the eye point.

However, when there is a large angle made between the angle of incidence of illuminating light from the illuminating means and the optical axis of the finder, the angle made between a normal to the first slanting facet of the microprism and the optical axis of the finder becomes small in the mode where the illuminating light is totally reflected at the first and second slanting facets, twice at each. Accordingly, when a range-finding point display is viewed while superimposed on an object image, the first slanting facet is seen through, and the effect of refraction by the first slanting facet causes images at positions off the periphery to be seen too. There is thus a problem with the visibility of range-finding point displays.

### SUMMARY OF THE INVENTION

Having been made with the aforesaid problems in mind, the invention has for its object to provide a compact in-finder display apparatus that is used on a single-lens reflex camera comprising a penta roof prism or the like to produce superimposed displays, and prevent the camera from growing bulky.

Having been made with the aforesaid problems in mind, the invention has for another object to provide an in-finder display apparatus capable of producing superimposed displays, wherein even when there is a large angle between the angle of incidence of illuminating light rays from an illumination means and the optical axis of a finder, illuminating light can reliably be guided to an eye point without detrimental to the visibility of range-finding points and albeit being structurally simplified.

The aforesaid object or objects are accomplishable by the provision of an in-finder display apparatus comprising a finder optical system adapted to view an object image formed by a taking lens on a focal plane plate by means of an eyepiece lens through a penta roof prism, a display cell located on a display member disposed near an imaging plane for the object image, and an illuminating means for illuminating said display cell, wherein said display cell is illuminated by said illuminating means so that light reflected off said display cell together with the object image is viewable via said finder optical system, said illuminating optical system comprises a light emitting means and a light projecting lens for converging a light beam leaving said light emitting means, and said illuminating optical system is positioned such that an illuminating light beam leaving said light emitting means in said illuminating optical system enters said display cell after transmitting through said light projecting lens.

The illuminating light beam from the illuminating optical system adapted to produce superimposed displays takes an optical path from the light emitting means to the display member to apply direct illumination to the display member not via a penta roof prism; there is no need of increasing the size of the penta roof prism while taking care of an illuminating light beam within the finder, contributing to size reductions. There is also no need of extending an optical path within the penta prism on the optical axis of the finder optical system: this works for increasing the magnification of the finer without extending the focal length. Further, there is no need of locating the light emitting means and the aforesaid light guide means on the top surface or the like of the aforesaid penta roof prism: it is possible to efficiently locate parts that form the in-finder display apparatus and make the whole apparatus compact.

For the aforesaid invention it is preferable to satisfy any one of the following arrangements.

It is preferable that the illuminating optical system in the inventive in-finder display apparatus implements illumination such that a light beam from the light emitting means is not imaged on the surface of the display member on which the display cell is located.

As noted previously, an LED is generally used as the illuminating light emitting means for producing superimposed displays. With the illuminating light from the LED, however, wire bonding casts a shadow; to hide that shadow, a diffusing plate has to be located on the optical path to diffuse the illuminating light. Here, if the light beam from the light emitting means is not imaged on the display member, it is then possible to hide the shadow cast by wire bonding without inserting any diffusing plate, thereby simplifying the arrangement involved. No use of any diffusing plate also leads to lower costs.

For the light beam guided from the illuminating optical system to the display member in the in-finder display apparatus, it is preferable to satisfy the following conditions (1) and (2):

60°<θmax<80° (1)

40°<θmin (2)

where θmax is the maximum value of the angle of incidence of the illuminating light beam with respect to a normal to the surface of the aforesaid display member on the penta prism side, and

θmin is the minimum value of the angle of incidence of the illuminating light beam with respect to a normal to the surface of the aforesaid display member on the penta prism side.

Conditions (1) and (2) define limitations about the angle of incidence of the chief ray of illuminating light with respect to the normal to the surface of the display member on the penta prism side. Exceeding the upper limit of 80° to condition (1) is not preferable for the projection of illuminating light, because there is a sharp rise in the reflectivity of the entrance surface of the display member. Being in short of the lower limit of 60° to condition (1) works against increasing the magnification of the finder, because there is inevitably a longer air space created between the focal plane plate and the entrance surface of the penta prism. Being in short of the lower limit of 40° to condition (2) is not preferable, because the illuminating light is directed to the focal plane plate after passing through the display member, and there is high likelihood of the ensuing diffused light going back to the pupil.

More preferably, condition (1) should be narrowed down to:

65°<θmax<78° (1′)

More preferably, condition (2) should be narrowed down to

45°<θmin (2′)

For the illuminating optical system in the in-finder display apparatus, it is preferable to comprise a light projecting lens having a toric surface differing in curvature depending on the direction of longitude, and satisfy the following condition (3):

0.4<R2y/R2x<0.9 (3)

where R2x is the radius of curvature of the display member side surface of the light projecting lens in the direction vertical to a plane made between a normal to the entrance surface of the display member and the optical axis of the light projecting optical system, and

R2y is the radius of curvature of the display member side surface of the light projecting lens in the direction parallel with a plane made between a normal to the entrance surface of the display member and the optical axis of the light projecting optical system.

Condition (3) defines the light emitting means side surface of the light projecting lens in the illuminating optical system. Illuminating light provided by the illuminating optical system on the display member takes on an oval range of illumination on the surface of the display member on which the display cell is located, although depending on the angle of incidence. If the lens surface of the light projecting lens is constructed of a toric surface differing in curvature depending on the direction of longitude, it is then possible to adjust the range of projection of light on the display member surface, and if the range of projection is configured into a substantially near-circle shape, it is then possible to prevent light rays from striking upon other display cells to put them on at the same time.

As the lower limit of 0.4 to condition (3) is not reached, the shape of the range of projection of light extends out in the direction vertical to the plane made between the normal to the entrance surface of the display member and the optical axis of the illuminating optical system, resulting in other display cells being put on at the same time. And because the range of projection of light grows wide, brightness gets dark when the display cell is on.

As the upper limit of 0.9 to condition (3) is exceeded, it does not permit the shape of the range of projection of light to make sure an adequate range in the direction vertical to the plane made between the normal to the entrance surface of the display member and the optical axis of the illuminating optical system; when there is a shift of the range of projection of light due to the assembling of the display member or fabrication errors of the light projecting lens, the display member cannot fully be put on.

More preferably, condition (3) should be narrowed down to:

0.5<R2y/R2x<0.85 (3′)

For the illuminating optical system in the in-finder display apparatus, it is preferable to comprise a light projecting lens having a toric surface differing in curvature depending on the direction of longitude, and satisfy the following condition (4):

−1.5<R1y/R1x<1.0 (4)

where R1x is the radius of curvature of the light emitting means side surface of the light projecting lens in the direction vertical to a plane made between a normal to the entrance surface of the display member and the optical axis of the light projecting lens, and

R1y is the radius of curvature of the light emitting means side surface of the light projecting lens in the direction parallel with a plane made between a normal to the entrance surface of the display member and the optical axis of the light projecting lens.

Condition (4) defines the radius of curvature of the light emitting means side surface of the light projecting lens in the illuminating optical system. Although it is preferable that the light emitting means is brightly put on in the superimposing mode, yet it is preferable to guide as much light beam as possible to the light projecting lens, other than increasing the quantity of light from the light emitting member. To this end it is preferable to locate the light projecting lens as close to the light emitting member as possible; however, it is then difficult to properly put on the respective display cells arranged in a matrix form.

Here, if the surface of the light projecting lens on the light emitting means side is made up of a toric surface differing in curvature depending on the direction of longitude, it is then possible to locate the light projecting lens as close to the light emitting member as possible, and if the range of projection of light is configured into a substantially near-circle shape, it is then possible to prevent light rays from striking upon other display cells to put them on at the same time.

As the lower limit of −1.5 to condition (4) is not reached, the shape of the range of projection of light extends out in the direction vertical to the plane made between the normal to the entrance surface of the display member and the optical axis of the illuminating optical system, resulting in other display cells being put on at the same time. And because the range of projection of light grows wide, brightness gets dark when the display unit is on.

As the upper limit of 1.0 to condition (4) is exceeded, it does not permit the shape of the range of projection of light to make sure an adequate range in the direction vertical to the plane made between the normal to the entrance surface of the display member and the optical axis of the illuminating optical system; when there is a shift of the range of projection of light due to the assembling of the display member or fabrication errors of the light projecting lens, the display member cannot fully be put on.

More preferably, condition (4) should be narrowed down to:

−1.2<R1y/R1x<0.8 (4′)

The aforesaid object or objects of the invention is accomplishable by the provision of an imaging optical system comprising a finder optical system for viewing an object image formed by a taking lens on a focal plane plate, a display cell located on a display member disposed near an imaging plane for the object image and an illuminating optical system for illuminating said display cell and capable of viewing light reflected off said display cell together with the object image via said finder optical system, wherein said display member comprises a first transmitting surface, a second transmitting surface opposite to said first transmitting surface and said display cell, said display cell is made up of a roof type microprism opposite to said first transmitting surface, said roof type microprism comprises a first slanting facet and a second slanting facet with a ridgeline lying in the direction vertical to the direction of projecting light from said illuminating optical system, illuminating light incident from said illuminating optical system is reflected such that it enters said display member from said first transmitting surface, leaves said display member from said second transmitting surface, reenters said display member from said first slanting facet, is only once totally reflected at said second slanting facet, leaves said display member from said first transmitting surface, and is guided into the pupil of a viewer via the finder optical system.

The display unit is made up of the roof type micro-prism, and illuminating light from the illuminating optical system is not subject to total reflection at the first of the first and second slanting facets of said roof type microprism. Thus, even when there is a large angle made between the angle of incidence of illuminating light rays from the illuminating means and the optical axis of the finder, it is then possible to make the angle made between the normal to the first slanting facet and the optical axis of the finder larger than a critical angle at the refractive index of the resin vitreous material used for the display cell, thereby making sure the visibility of a range-finding point and the reflection efficiency of illuminating light without being seen through upon viewing.

Preferably, the aforesaid invention should have any one of the following requirements.

For the inventive in-finder display apparatus, it is preferable that said second transmitting surface is vertical to the optical axis of the finder, and said roof type microprism has in section an isosceles triangle shape whose equilaterals are defined by said first slanting facet and said second slanting facet, with the satisfaction of such a condition as mentioned just below.

70°<θ<90° (1)

Here θ is the angle made between said first slanting facet and said second slanting facet.

When the microprism forming the display cell is an isosceles triangle whose equilaterals are defined by the first and the second slanting facet, condition (1) defines the optimum angle made between those first and second slanting facets.

As the upper limit of 90° to condition (1) is exceeded, a range-finding point cannot be put on, because the projected light rays cannot reenter the first slanting facet after passing through the display member. This also causes the angle made between the optical axis of the finder and the normal to each surface to become small, so that both the slanting facets are seen through upon viewing via the finder, working against the visibility of the range-finding point.

As the lower limit of 70° to condition (1) is not reached, any range-finding point cannot be put on, because the light reflected off the second slanting facet does not go back to the pupil of the viewer along the optical axis of the finder.

More preferably, condition (1) should be narrowed down to:

75°<θ<85° (1′)

For the inventive in-finder display apparatus, it is preferable that said second transmitting surface is vertical to the optical axis of the finder, and said roof type microprism has in section a triangle shape free of any equilaterals, with the satisfaction of such conditions as mentioned just below.

45°<θ<90° (2)

0°<θ₁<50° (3)

Here θ is the angle made between said first slanting facet and said second slanting facet that form said triangle, and

θ₁ is the angle made between the optical axis of the finder and the first slanting facet.

When the microprism set up on the display member is a triangle free of any equilaterals, conditions (2) and (3) define the optimum angle made between the first slanting facet and the second slanting facet.

As the upper limit of 90° to condition (2) is exceeded, any range-finding point cannot be put on, because the light reflected off the second slanting facet does not go back to the pupil of the viewer along the optical axis of the finder. This also causes the angle made between the optical axis of the finder and the normal to the second slanting facet to become so small that the second slanting facet is seen through upon viewing via the finder, adversely affecting the visibility of the range-finding point.

As the lower limit of 45° to condition (2) is not reached, the same happens: any range-finding point cannot be put on, because the light reflected off the second slanting facet does not go back to the pupil of the viewer along the optical axis of the finder.

More preferably, condition (2) should be narrowed down to:

50°<θ<85° (2′)

As the upper limit of 85° to condition (3) is exceeded, any range-finding point cannot be put on, because the light reflected off the second slanting facet does not go back to the pupil of the viewer along the optical axis of the finder. This also causes the angle made between the optical axis of the finder and the normal to the first slanting facet to become so small that the first slanting facet is seen through upon viewing via the finder, adversely affecting the visibility of the range-finding point.

As the lower limit of 50° to condition (3) is not reached, any mold shape for resins is not available: it is difficult to fabricate microprisms by molding.

More preferably, condition (3) should be narrowed down to:

0°<θ₁<40° (3′)

Still objects and advantages of the invention will in part be obvious and will in part be apparent from the specification.

The invention accordingly comprises the features of construction, combinations of elements, and arrangement of parts which will be exemplified in the construction hereinafter set forth, and the scope of the invention will be indicated in the claims.

### BRIEF DESCRIPTION OF THE DRAWINGS

FIG. 1 is illustrative in arrangement of the in-finder display apparatus according to the first, and the third embodiment of the invention that is mounted on a camera, as viewed from the object side and above.

FIG. 2 is illustrative in arrangement of the in-finder display apparatus according to the second embodiment of the invention that is mounted on a camera, as viewed from side and above.

FIG. 3 is illustrative of one example of the position of a range-finding frame in the inventive display member.

FIG. 4 is a detailed view of the display cell in the invention.

FIG. 5 is illustrative in section of the display member parallel with the optical axis of the finder, and in schematic of an illuminating optical path taken by light rays that are incident from the illuminating optical system and reflected at the display member parallel with the optical axis of the finder.

FIG. 6 is illustrative in section of the display member wherein the microprism at the display cell is configured into an isosceles triangle shape whose equilaterals are defined by the first and second slanting facets, and in schematic of an illuminating optical path taken by light rays that are incident from the illuminating optical system and reflected at the display member parallel with the optical axis of the finder.

FIG. 7 is a detailed view of an illuminating optical path taken by light transmitting through the microprism of FIG. 6.

FIG. 8 is illustrative in section of the display member wherein the microprism at the display cell is configured into a triangle shape free of equilaterals, and in schematic of an illuminating optical path taken by light rays that are incident from the illuminating optical system and reflected at the display member parallel with the optical axis of the finder.

FIG. 9 is a detailed view of an illuminating optical path taken by light transmitting through the microprism of FIG. 8.

FIG. 10 is illustrative in schematic and section of part of a conventional in-finder display apparatus within a camera.

FIG. 11 is illustrative in schematic and section of part of a conventional in-finder display apparatus within a camera.

### DESCRIPTION OF EXEMPLARY EMBODIMENTS

The invention is now explained with reference to the examples illustrated in the accompanying drawings.

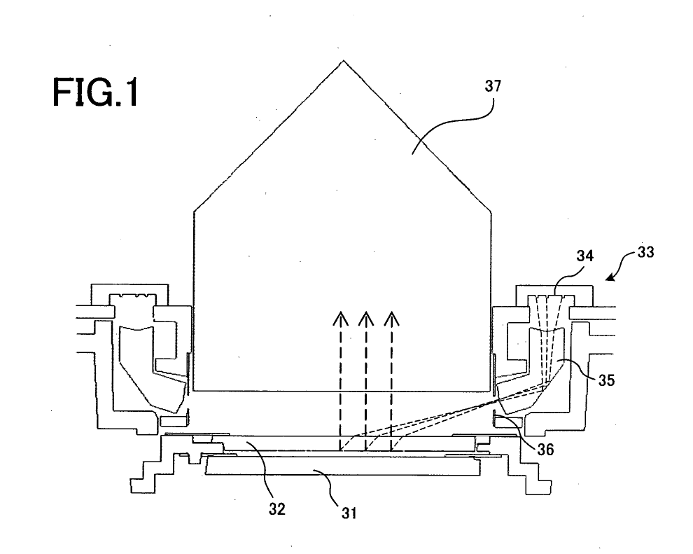

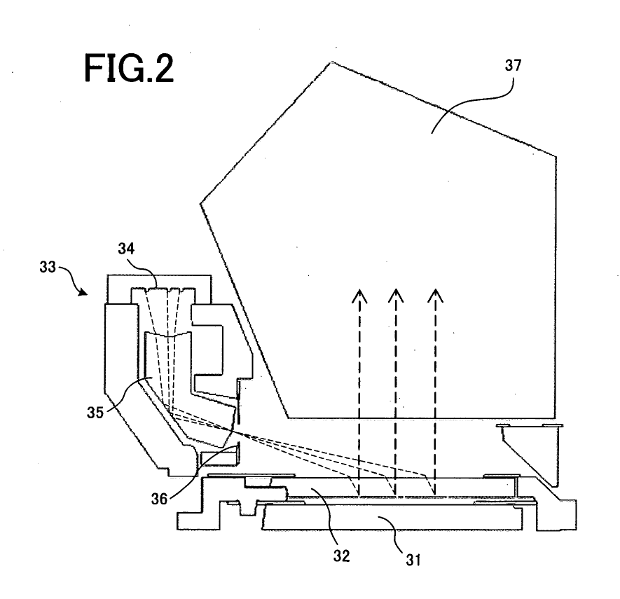

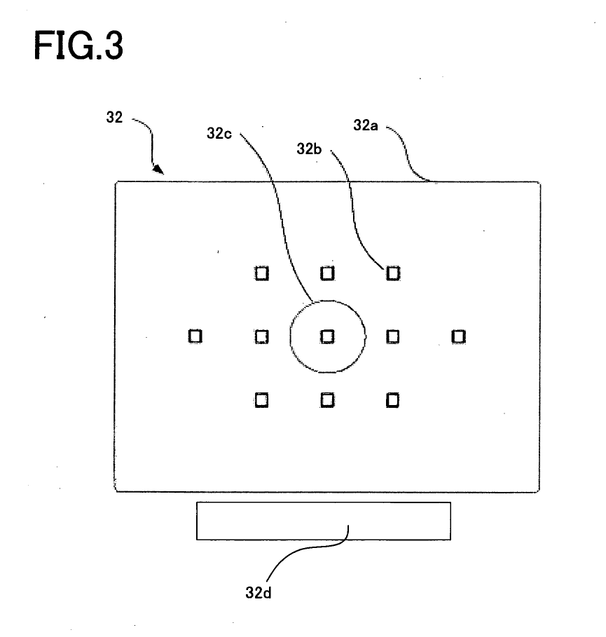

FIG. 1 is illustrative in arrangement of the in-finder display apparatus according to the first, and the third embodiment of the invention that is mounted on a camera, as viewed from the object side and above; FIG. 2 is illustrative in arrangement of the in-finder display apparatus according to the second embodiment of the invention, as viewed from side and above; and FIG. 3 is illustrative of one example of the position of a range-finding frame in the inventive display member.

Each example will be understood from the explanation of the arrangement of FIG. 1. In FIG. 1, object image light rays from a taking optical system are incident from below the drawing, and transmit through a focal plane plate 31 and a display member 32. Then, the image is erected by a penta roof prism 37 into an erected image that is then guided to the pupil of an operator (viewer) via an eyepiece optical system.

In this embodiment, an illuminating optical system 33 comprised of a base plate 34 having a light emitting member as a light emitting means and a light projecting lens 35 is located on one side of the penta roof prism 37. The base plate 34 has a structure comprising a plurality of light emitting sources (e.g., an LED array). Illuminating light emitted from each light emitting source transmits through the light projecting lens 35 and then passes through a stop 36. Then, it passes through a space outside the penta roof prism 37 without passing through the penta roof prism 37, making its way through a space between the penta roof prism 37 and the display member 32. Then, it applies direct illumination to the associated range-finding point display cells 32b lying in a field frame 32a on the display member 32 shown in FIG. 3. As the selected range-finding point is illuminated, the illuminating light directed onto the display member 32 is reflected at the range-finding point display cell 32b alone in the display member 32 in the direction parallel with the optical axis of the taking optical system. With the reflected light, the operator (viewer) can implement viewing from the penta roof prism 37 via the eyepiece optical system. Note here that reference numeral 32c is indicative of a display cell for a photometric range for estimation, and 32d is indicative of an information display unit.

Here, light emitting sources on the light emitting member within the illuminating optical system 33 are located on grating points at a pitch of 0.8 mm. Like the light emitting sources, range-finding point display cells 32b on the display member 32 are located on the grating points at a pitch of 2.7 mm, as shown in FIG. 3.

The light projecting lens 35 disposed in the illuminating optical system 33 of FIG. 1 is a prism including an entrance surface, a reflecting surface and an exit surface. In order for the light projecting lens 35 to adjust an optical path taken by illuminating light from the light emitting sources to direct it onto the associated, desired range-finding point display cells 32b, the entrance and exit surfaces for illuminating light are allowed to have curvatures. To the exit surface side of the light projecting lens 35 there is a toric surface applied, whose curvature varies in the directions vertical to and parallel with a plane created between a normal to the entrance surface of the display member 32 and the optical axis of the taking optical system, so that the illuminating light directed onto the range-finding point display cell 32b is configured into a substantially near-circle shape.

Tabulated in Table 1 are lens data about the light projecting lens 35 used in Example 1, and tabulated in Table 3 are those about the light projecting lens 35 used in Example 3. The x-direction and y-direction here are defined by the directions vertical to and parallel with the plane created between the normal to the entrance surface of the display member 32 and the optical axis of the light projecting optical system: Rx is indicative of curvature in the x-direction and Ry is indicative of curvature in the y-direction. The capital D is the surface spacing of each optical surface, Nd is the d-line refractive index of the vitreous material used, ε is the angle made between the optical axis of the light projecting lens and the normal to the penta prism side surface of the display member 32, and δ is the distance between the optical axis of the finder and the vertex of the light projecting lens 35 on the display member side. The light projecting lens 35 is indicated by the first surface (entrance surface) and the second surface (exit surface), and the reflecting surface is not included in the lens data. The third surface is given by the stop 36, and the fourth and fifth surfaces are given by the top and bottom surfaces of the display member, respectively. By configuring the light projecting lens 35 as set forth in Table 1, the illuminating light directed onto the range-finding point display cell 32b takes on a substantially circular shape.

The second example will be understood from the explanation of the arrangement of FIG. 2. In FIG. 2, object image light rays from a taking optical system are incident from below the drawing, and transmit through a focal plane plate 31 and a display member 32. Then, the image is erected by a penta roof prism 37 into an erected image that is then guided to the pupil of an operator (viewer) via an eyepiece optical system.

In this embodiment, an illuminating optical system 33 comprised of a base plate 34 having a light emitting member and a light projecting lens 35 is located in a space on the side of the penta roof prism 37 facing away from a loupe system of the finder. The base plate 34 having a light emitting member has a structure comprising a plurality of light emitting sources (e.g., an LED array), as is the case with Example 1. Illuminating light emitted from each light emitting source transmits through the light projecting lens 35 and then passes through a stop 36. Then, it makes its way through a space between the penta roof prism 37 and the display member 32 without passing through the penta roof prism 37. Then, it applies direct illumination onto the associated range-finding point display cells 32b lying in a field frame 32a on the display member 32 shown in FIG. 3. As the selected range-finding point is illuminated, the illuminating light directed onto the display member 32 is reflected at the range-finding point display cell 32b alone in the display member 32 in the direction parallel with the optical axis of the taking optical system. With the reflected light, the operator (viewer) can implement viewing from the penta roof prism 37 via the eyepiece optical system.

Here, light emitting sources on the light emitting member within the illuminating optical system 33 are located on grating points at a pitch of 0.8 mm. Like the light emitting sources, range-finding point display cells 32b on the display member 32 are located on the grating points at a pitch of 2.7 mm.

The light projecting lens 35 disposed in the illuminating optical system 33 of FIG. 2 is a prism including an entrance surface, a reflecting surface and an exit surface. In order for the light projecting lens 35 to adjust an optical path taken by illuminating light from the light emitting sources to direct it onto the associated, desired range-finding point displays 32b, the entrance and exit surfaces for illuminating light are allowed to have curvatures. To the exit surface side of the light projecting lens 35 there is a toric surface applied, whose curvature varies in the directions perpendicular to and parallel with a plane created between a normal to the entrance surface of the display member 32 and the optical axis of the taking optical system, so that the illuminating light directed onto the range-finding point display cell 32b is configured into a substantially near-circle shape.

Tabulated in Table 2 are lens data about the light projecting lens 35 used in Example 2. The x-direction and y-direction here are defined by the directions vertical to and parallel with the plane created between the normal to the entrance surface of the display member 32 and the optical axis of the light projecting optical system: Rx is indicative of curvature in the x-direction and Ry is indicative of curvature in the y-direction. The capital D is the surface spacing of each optical surface, Nd is the d-line refractive index of the vitreous material used, e is the angle made between the optical axis of the light projecting lens and the normal to the penta prism side surface of the display member 32, and δ is the distance between the optical axis of the finder and the vertex of the light projecting lens 32 on the display member side. The light projecting lens 35 is indicated by the first surface (entrance surface) and the second surface (exit surface), and the reflecting surface is not included in the lens data. The third surface is given by the stop, and the fourth and fifth surfaces are given by the top and bottom surfaces of the display member, respectively. By configuring the light projecting lens 35 as set forth in Table 2, the illuminating light directed onto the range-finding point display 32b takes on a substantially near-circle shape.

While, in Examples 1, 2 and 3, the entrance or exit surface of the light projecting lens 35 is configured into a toric surface shape thereby configuring the illuminating light directed onto the range-finding point display 32b into a substantially near-circle shape, it is understood that when there is a reflecting surface included in the light projecting lens 35, the toric surface may then be applied to that reflecting surface.

TABLE 1
Example 1
Unit mm
Surface Data

| Surface No. | Ry | Rx | D | nd | νd | ε | δ |
|---|---|---|---|---|---|---|---|
| Light Source | | | 3 | | | | |
| 1 | −2.55 | ∞ | 8.5 | | | | |
| (Toric Surface) | | | | | | | |
| 2 | −3.00 | −4.2 | | 1.58107 | 30.49 | | |
| (Toric Surface) | | | | | | | |
| 3 | | | 2.88 | | | −72° 45′ | 10.17 |
| (Stop) | | | | | | | |
| 4 | ∞ | | 1.2 | 1.52384 | 55.78 | | |
| 5 | ∞ | | | | | | |
| Display Cell | | | | | | | |

TABLE 2
Example 2
Unit mm
Surface Data

| Surface No. | Ry | Rx | D | nd | νd | ε | δ |
|---|---|---|---|---|---|---|---|
| Light Source | | | 2 | | | | |
| 1 | −4.0 | | 8 | | | | |
| 2 (Toric Surface) | −3.0 | −4.0 | | 1.58107 | 30.49 | | |
| 3 (Stop) | | | 2.7 | | | −70° 30′ | 9 |
| 4 | ∞ | | 1.2 | 1.52384 | 55.78 | | |
| 5 | ∞ | | | | | | |
| Display Cell | | | | | | | |

TABLE 3
Example 3
Unit mm
Surface Data

| Surface No. | Ry | Rx | D | nd | νd | ε | δ |
|---|---|---|---|---|---|---|---|
| Light Source | | | 3 | | | | |
| 1 (Toric Surface) | −2.55 | 2.65 | 8.5 | | | | |
| 2 (Toric Surface) | −3.12 | −6.9 | | 1.58107 | 30.49 | | |
| 3 (Stop) | | | 2.7 | | | −72° 45′ | 10.17 |
| 4 | ∞ | | 1.2 | 1.52384 | 55.78 | | |
| 5 | ∞ | | | | | | |
| Display Cell | | | | | | | |

Tabulated below are the values of conditions (1), (2), (3) and (4) in the aforesaid examples.

| Condition | Example 1 | Example 2 | Example 3 |
|---|---|---|---|
| (1) | 76.5° | 75.8° | 76.5° |
| (2) | 67.2° | 62.6° | 67.2° |
| (3) | 0.714 | 0.750 | 0.452 |
| (4) | 0 | 1.0 | −0.962 |

The invention is further explained with reference to other examples shown in the accompanying drawings.

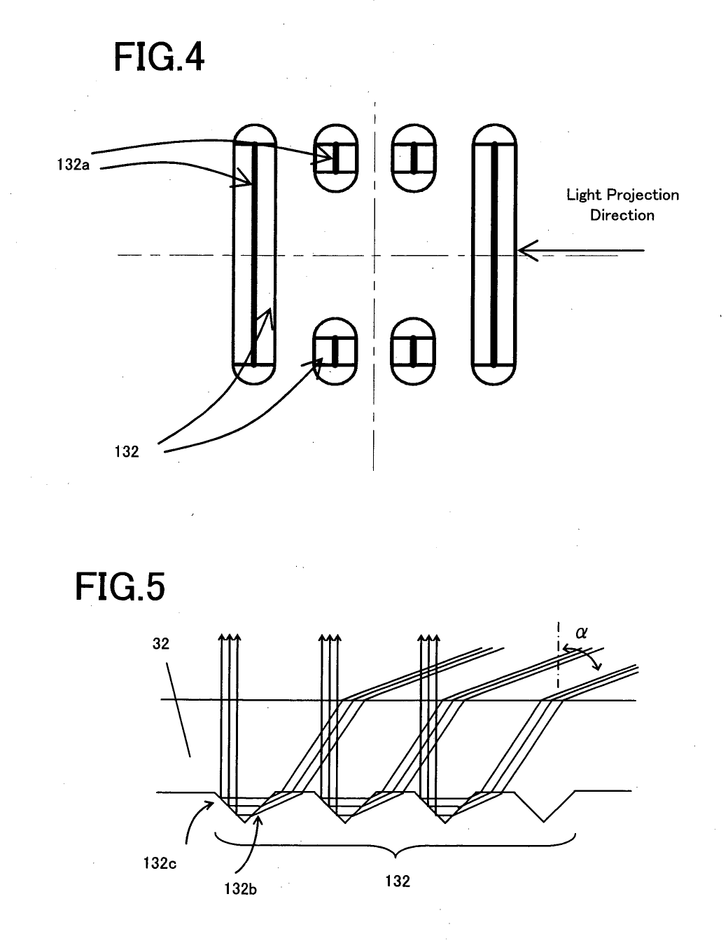

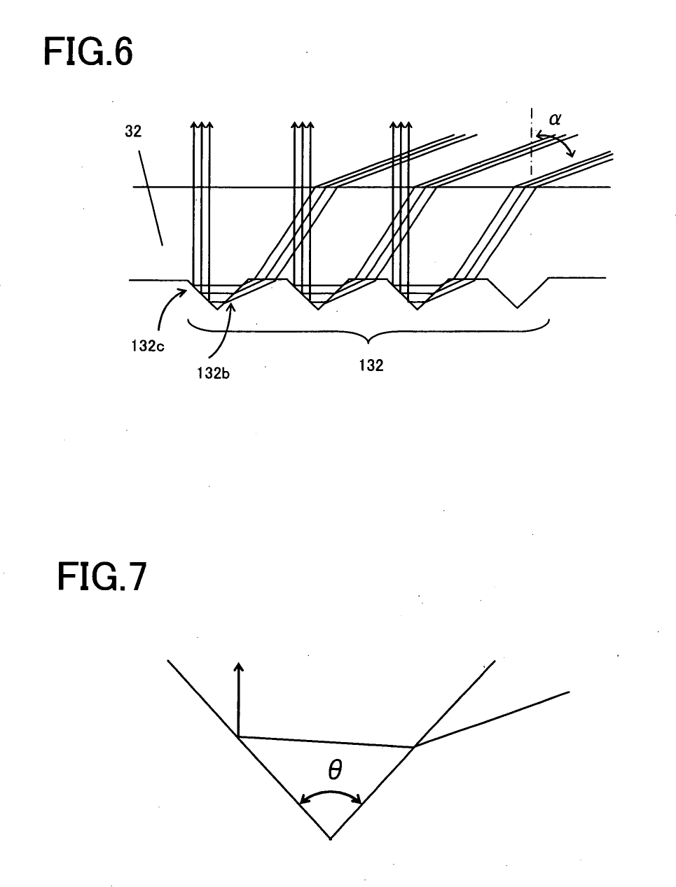

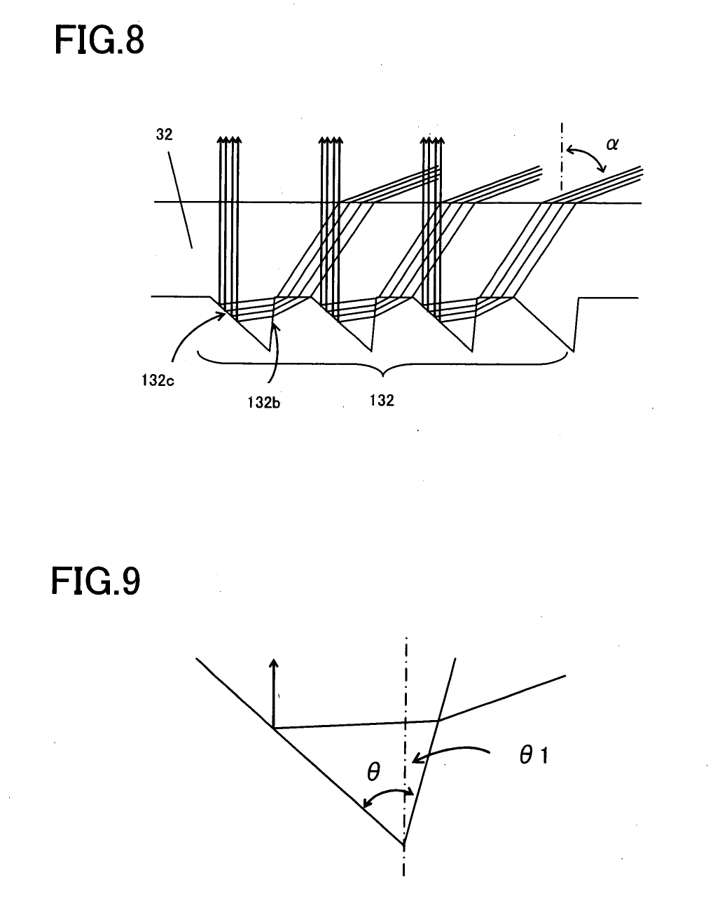

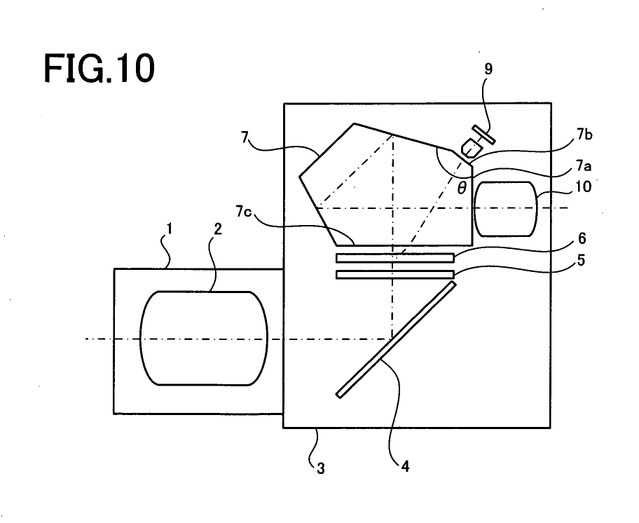

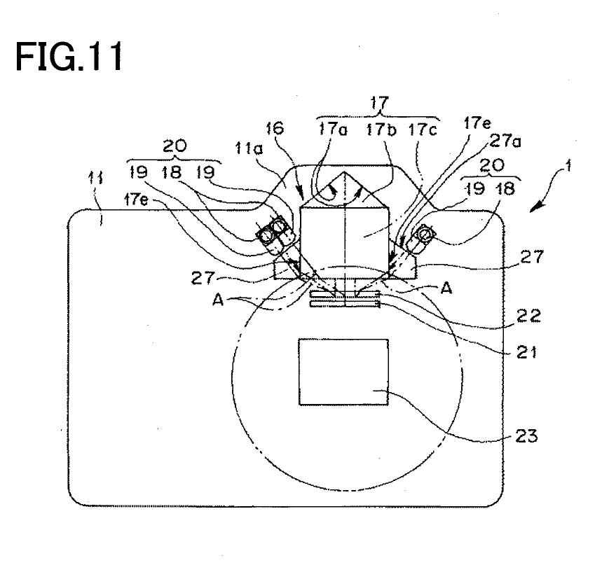

FIG. 4 is a detailed view of the display cell in the invention; FIG. 5 is illustrative in section of the display member parallel with the optical axis of the finder, and in schematic of an illuminating optical path taken by light rays that are incident from the illuminating optical system and reflected at the display member parallel with the optical axis of the finder; FIG. 6 is illustrative in section of the display member wherein the microprism at the display cell is configured into an isosceles triangle shape whose equilaterals are defined by the first and second slanting facets, and in schematic of an illuminating optical path taken by light rays that are incident from the illuminating optical system and reflected at the display member parallel with the optical axis of the finder; FIG. 7 is a detailed view of an illuminating optical path taken by light transmitting through the microprism of FIG. 6; FIG. 8 is illustrative in section of the display member wherein the microprism at the display cell is configured into a triangle shape free of equilaterals, and in schematic of an illuminating optical path taken by light rays that are incident from the illuminating optical system and reflected at the display member parallel with the optical axis of the finder; and FIG. 9 is a detailed view of an illuminating optical path taken by light transmitting through the microprism of FIG. 8.

FIG. 4 is one example of the detailed view wherein each range-finding point display cell of FIG. 3 is shown on an enlarged scale. There are microprisms 132 arranged, each one shown in a substantially rectangular shape in a substantially oval contour. The ridgeline of the micro-prism 132 turns vertically to the direction of incident light from the light projecting lens 35, as shown by a thick line in the microprism 132. By turning the ridgeline 132a vertically to the direction of incident light from the light projecting lens 35, it is possible to make sure the illuminating light is reflected toward the eye point thereby enhancing its visibility.

FIG. 5 is a sectional view of the display member 32 in FIGS. 3 and 4 as cut along a plane parallel with the optical axis of the finder, and shows an optical path taken in the fourth embodiment by reflected light of the illuminating light. In FIG. 5, a display member 32 includes a first transmitting surface 32₁, a second transmitting surface 32₂ opposite to the first transmitting surface 32₁ and a display cell 32b. The display cell 32b is constructed of a roof type microprism 132 opposite to the first transmitting surface 32₁. The microprism 132 has a first slanting facet 132b and a second slanting facet 132c with the ridgeline 132 turning vertically to the direction of projection of light from the illuminating optical system 33. Illuminating light incident from the illuminating optical system 33 at an angle α to the optical axis of the finder enters the display member 32 from the first transmitting surface 32₁, and leaves the display member 32 from the second transmitting surface 32₂. Then, it reenters the display member 32 from the first slanting facet 132b, and is totally reflected at the second slanting facet 132c only once, leaving the display member 32 from the first transmitting surface 32₁. Then, it is guided to the pupil of the viewer after transmitting through the penta roof prism. Even when the angle of incidence α of illuminating light is large, there is no need of forcibly decreasing the angle made between the optical axis of the finder and the normal to the first and second slanting facets 132b and 132c because of no total reflection at the first slanting facet 132b of the microprism 132. Accordingly, upon viewing through the finder, the first and second slating facets 132b and 132c remain invisible to the viewer so that visibility can be improved.

The fifth embodiment of the invention is now explained with reference to FIGS. 6 and 7. FIG. 6 is a sectional view of the display member that is set up in the form of an isosceles triangle whose equilaterals are defined by the first and second slanting facets 123b and 132c that the microprism 132 of FIG. 5 has.

In FIG. 6, incident light from the illuminating optical system enters the display member 32 from the first transmitting surface 32₁ at an angle α to the optical axis of the finder, and leaves the display member 32 from the second transmitting surface 32₂ vertical to the optical axis of the finder, as is the case with FIG. 5. Then, it enters the first slanting facet 132b of the microprism 132 through the air, again transmitting through the display member 32. Then, it is totally reflected at the second slanting facet 132c, entering the penta roof prism 37 in the form of a light beam parallel with the optical axis of the finder. FIG. 7 is an enlarged view of how this illuminating light beam is incident onto the microprism 132.

For instance, suppose now that the angle of incidence of the illuminating light beam to the optical axis of the finder is α=70°, and the refractive index of the display member 32 is nd=1.50913. If the angle made between the first and second slanting facets 132b and 132c is set at θ=84° because the critical angle of the micro-prism is θ_{c}=41.5°, the illuminating light beam will transmit through the first slanting surface 132b and be totally reflected at the second slanting facet 132c, becoming a light beam parallel with the optical axis of the finder.

The sixth embodiment of the invention is now explained with reference to FIGS. 8 and 9. FIG. 8 is a sectional view of the display member 32 wherein the micro-prism 132 in FIG. 5 is set up in the form of a triangle free of equilaterals.

In FIG. 8, incident light from the illuminating optical system 33 enters the display member 32 from the first transmitting surface 32₁ at an angle α to the optical axis of the finder, and leaves the display member 32 from the second transmitting surface 32₂ vertical to the optical axis of the finder, as is the case with FIG. 5. Then, it enters the first slanting facet 132b of the microprism 132 through the air, again transmitting through the display member 32. Then, it is totally reflected at the second slanting facet 132c, entering the penta roof prism 37 in the form of a light beam parallel with the optical axis of the finder.

FIG. 9 is an enlarged view of how this illuminating light beam is incident onto the microprism 132. For instance, suppose now that the angle of incidence of the illuminating light beam to the optical axis of the finder is α=70°, the refractive index of the display member 32 is nd=1.50913, and the angle made between the optical axis of the finder and the first slanting facet 132b is set at θ₁=15°. If the angle made between the first and second slanting facets 132b and 132c is set θ=63.7° because the critical angle of the microprism is θ_{c}=41.5°, the illuminating light beam will transmit through the first slanting surface 132b and be totally reflected at the second slanting facet 132c, becoming a light beam parallel with the optical axis of the finder.

What is claimed is:

1. An in-finder display apparatus comprising:
a finder optical system adapted to view an object image formed by a taking lens on a focal plane plate by means of an eyepiece lens through a penta roof prism,
a display cell located on a display member disposed near an imaging plane for the object image, and
an illuminating optical system for illuminating said display cell, wherein:
said display cell is illuminated by said illuminating optical system so that light reflected off said display cell together with the object image is viewable via said finder optical system,
said illuminating optical system comprises:
a light emitting means, and
a light projecting means for converging a light beam leaving said light emitting means, and
said illuminating optical system is positioned such that an illuminating light beam leaving said light emitting means in said illuminating optical system enters said display cell after transmitting through said light projecting lens.

2. The in-finder display apparatus according to claim 1, wherein:
the illuminating light beam leaving the light emitting means in the illuminating optical system is not imaged on a surface of the display member.

3. The in-finder display apparatus according to claim 1, which satisfies the following conditions (1) and (2)
60°<θmax<80° (1)
40°<θmin (2)
where θmax is a maximum value of an angle of incidence of the illuminating light beam with respect to a normal to a surface of said display member on a penta prism side, and
θmin is a minimum value of the angle of incidence of the illuminating light beam with respect to a normal to the surface of said display member on the penta prism side.

4. The in-finder display apparatus according to claim 1, wherein said illuminating optical system comprises a light projecting lens having a toric surface that varies in curvature depending on longitude, with satisfaction of the following condition (3):
0.4<R2y/R2x<0.9 (3)
where R2x is a radius of curvature of a display member side surface of the light projecting optical system in a direction vertical to a plane made between a normal to the entrance surface of the display member and the optical axis of the light projecting optical system, and
R2y is a radius of curvature of the display member side surface of the light projecting optical system in a direction parallel with the plane made between a normal to the entrance surface of the display member and the optical axis of the light projecting optical system.

5. The in-finder display apparatus according to claim 1, wherein said illuminating optical system comprises a light projecting lens having a toric surface that varies in curvature depending on longitude, with satisfaction of the following condition (4):
−1.5<R1y/R1x<1.0 (4)
where R1x is a radius of curvature of a light emitting means side surface of the light projecting optical system in a direction vertical to a plane made between a normal to the entrance surface of the display member and the optical axis of the light projecting optical system, and
R1y is a radius of curvature of the light emitting means side surface of the light projecting optical system in a direction parallel with a plane made between a normal to the entrance surface of the display member and the optical axis of the light projecting optical system.

6. An in-finder display apparatus comprising:
a finder optical system for viewing an object image formed by a taking lens on a focal plane plate,
a display cell located on a display member disposed near an imaging plane for the object image, and
an illuminating optical system for illuminating said display cell and capable of viewing light reflected off said display cell together with the object image via said finder optical system, wherein:
said display member comprises:
a first transmitting surface,
a second transmitting surface opposite to said first transmitting surface, and
said display cell, wherein:
said display cell comprises a roof type microprism opposite to said first transmitting surface,
said roof type microprism comprises a first slanting facet, and
a second slanting facet, with a ridgeline lying in a direction vertical to a direction of projecting light from said illuminating optical system, and
an illuminating light beam incident from said illuminating optical system takes an optical path such that it enters said display member from said first transmitting surface, leaves said display member from said second transmitting surface, reenters said display member from said first slanting facet, is only once totally reflected at said second slanting facet, and leaves said display member from said first slanting facet.

7. The in-finder display apparatus according to claim 6, wherein said roof type microprism has in section an isosceles triangle shape whose equilaterals are given by said first slanting facet and said second slanting facet, with satisfaction of the following condition (5):
70°<θ<90° (5)
where θ is an angle made between said first slanting facet and said second slanting facet.

8. The in-finder display apparatus according to claim 6, wherein said roof type microprism has a triangle shape free from equilaterals, with satisfaction of the following conditions (6) and (7):
45°<θ<90° (6)
0°<θ₁<50° (7)
where θ is an angle made between said first slanting facet and said second slanting facet, and
θ₁ is an angle made between the optical axis of the finder and the first slanting facet.
